(19) United States
(12) Patent Application Publication
(10) Pub. No.: US 2013/0290128 A1
(43) Pub. Date: Oct. 31, 2013

(54) Methods and Systems to Evaluate and Rank Bids Based At Least in Part on the Provider's Past Performance

(71) Applicants: Chithralekha Balamurugan, Pondicherry (IN); William K. Stumbo, Fairport, NY (US); Yu-An Sun, Webster, NY (US)

(72) Inventors: Chithralekha Balamurugan, Pondicherry (IN); William K. Stumbo, Fairport, NY (US); Yu-An Sun, Webster, NY (US)

(73) Assignee: Xerox Corporation, Norwalk, CT (US)

(21) Appl. No.: 13/459,088

(22) Filed: Apr. 28, 2012

(51) Int. Cl. G06Q 30/08

(52) U.S. Cl. 705/26.4

(57) ABSTRACT

The application discloses systems and methods for evaluating bids submitted by providers in response to a reverse auction process initiated by a buyer. The disclosed system determines an attribute utility score of the bid and total performance scores of providers based on the past performance records of the providers. The total performance scores of providers are determined by computing a positive deviation score, a negative deviation score, a performance among peers score, and a bid performance score of the provider. The system further sums the determined attribute utility score and the total performance score to obtain a rank of the submitted bid.

### FIELD

The present application discloses a bid evaluation method. More particularly, the present application relates to a method for evaluating a bid submitted by a provider during an auction or request for proposal process.

### BACKGROUND

A request for proposal or reverse auction is a buyer-initiated bidding process in which a buyer invites bids from multiple providers. A large presence of providers enables buyers to select a provider of choice from a sizeable pool of potential providers, presenting opportunities for competitive quoting and yielding subsequent benefits to the buyers. However, in order to obtain competitive quotes, a buyer needs to identify a number of suitable service providers and obtain comparative quotes. If performed manually, this is a time consuming process.

Presently, a number of computer implemented methods are available to buyers for evaluating bids submitted by a plurality of providers, in order to select a suitable provider. For example, electronic reverse auctions are online mechanisms used by buyers to select a suitable provider to perform a task. Providers submit bids based on buyer-supplied criteria. The buyer awards the auctioned job to a most suitable provider from among a plurality of providers that submitted bids.

In such computer implemented methods, bid evaluation is a critical function. It is a decision making process that helps buyers to determine a most suitable bid, relative to the buyer-supplied criteria, by evaluating bids submitted by providers based on one or more attributes of the bid, and the corresponding values, quoted by the providers. Various multi-criteria decision analysis techniques such as multi-attribute utility theory (MAUT), analytic hierarchy process (AHP), and lexicographic ordering are often used as the bid evaluation function for auction mechanisms. Each technique has its own decision making function for evaluating bids.

MAUT is a widely used multi-criteria decision analysis technique, which utilizes an additive utility function. In this approach, the buyer evaluates each relevant attribute value, xⱼⁱ, of a bid through an attribute utility function, AU(xⱼⁱ), and indicates a relative importance value of each attribute by a weight, wᵢ. The overall utility for a bid is obtained by the summing of all weighted utilities of the attribute values. Thus for a bid that has values xⱼ¹ . . . xⱼⁿ on n attributes, the overall utility for a bid is obtained as:

U(xⱼ)=Σᵢ₌₁ⁿwᵢ*AUᵢ(xⱼⁱ) (A)

MAUT is popular as a bid evaluation function because of its simplicity and flexibility to scale to any number of attributes. However, the use of MAUT requires the buyer to specify the weights for each attribute of the bid.

AHP involves structuring a problem from a primary objective to multiple layers of objectives. Once these hierarchies have been established, a pairwise comparison matrix of each element within each level is constructed. This matrix is then transformed into weights based on a method such as Saaty's Eigen vector method.

Automatic determination of weights for the attributes of a bid is a challenging task. WORA (Weight Determination based on Ordinal Ranking of Alternatives) and Inverse Optimization are known techniques that use various intelligent approaches to determine attribute weights. Current research on improving bid evaluation utility functions focuses primarily upon simplifying the weight determination aspect.

A limitation of multiple criteria decision analysis techniques is that a bid is evaluated by taking into consideration only the quoted attribute values. However, bid evaluation may be considered comprehensive only when the quoted attribute values are evaluated in light of a provider's actual historical performance. Evaluating providers based on their past performances in executing auctioned jobs helps to ensure that the providers are capable of fulfilling the quoted value. However, known approaches to evaluating past performance of providers are highly subjective and fail to take into account a provider's positive deviations from a committed bid attribute (for example, finishing job before deadline, applying a discount, or giving other value additions which had not been earlier committed). Accordingly, these methods do not provide the ability to analyze the performance of a provider on varied historical objective perspectives and/or dimensions which help to construct a complete evaluation of the provider.

Hence, there is need for a bid evaluation function that provides a comprehensive evaluation of quoted attribute values along with an objective and complete provider evaluation based on data that is recorded during prior job executions.

### SUMMARY

In one embodiment, the application discloses a method for evaluating bids submitted by one or more providers in a reverse auctioning process. The specification discloses a method for evaluating a bid submitted by a provider during a bidding process, wherein said evaluation is performed by at least one processor executing instructions stored in a non-volatile memory, comprising: a) retrieving from a database a plurality of electronic records wherein said records comprise data representative of a provider's past performance with respect to one or more prior bids, wherein each of said prior bids comprise bid variables having associated therewith one or more bid variable values and wherein said data representative of a provider's past performance indicates whether said provider met, failed to meet, or performed better than said one or more bid variable values; b) determining a positive deviation score, wherein said positive deviation score is a measure of an extent to which the provider performed better than said one or more bid variable values and wherein said positive deviation score is only determined if the data representative of a provider's past performance indicates the provider did not fail to meet any of said one or more bid variable values; c) determining a negative deviation score, wherein said negative deviation score is a measure of an extent to which the provider failed to meet said one or more bid variable values and wherein said negative deviation score is only determined if the data representative of a provider's past performance indicates the provider did not perform better than any of said one or more bid variable values; and d) ranking said bid, wherein said ranking is a function of at least one of said positive deviation or negative deviation score.

Optionally, the variables comprise at least one of cost, quantity, or completion deadline. The positive deviation score is determined if and only if the provider delivered a product or service, in response to one of said prior bids, at a cost below the cost bid variable, in a quantity greater than the quantity bid variable, or at a time earlier than the completion deadline bid variable and if and only if the provider did not deliver a product or service, in response to one of said prior bids, at a cost greater than the cost bid variable, in a quantity less than the quantity bid variable, and at a time later than the completion deadline bid variable.

The negative deviation score is determined if and only if the provider delivered a product or service, in response to one of said prior bids, at a cost greater than the cost bid variable, in a quantity less than the quantity bid variable, or at a time later than the completion deadline bid variable and if and only if the provider did not deliver a product or service, in response to one of said prior bids, at a cost less than the cost bid variable, in a quantity greater than the quantity bid variable, and at a time earlier than the completion deadline bid variable.

Optionally, the ranking is achieved, at least in part, by summing a first score and a second score, wherein said first score is an attribute utility function. The attribute utility function is determined by using a MAUT or AHP methodology. The second score is determined by summing the positive deviation score, the negative deviation score, a third score, a fourth score, a fifth score, a sixth score, a seventh score, and an eighth score. The third score is a function of an average number of negative deviations of the provider and an average number of negative deviations of all providers engaged in said bidding process. The fourth score is a function of a total number of negative deviations of the provider across all recorded jobs and the average negative deviations of all providers engaged in said bidding process. The fifth score is a function of the provider's total number of positive deviations across all past performances for prior bids and the provider's total number of negative deviations across all past performances for prior bids.

Optionally, the sixth score is a function of individual bid evaluation scores for each of said prior bids relative to a total number of prior bids. The seventh score is a ratio of a number of the provider's accepted bids relative to a number of the provider's submitted bids. The provider is classified into a plurality of classes based upon at least one of said negative deviation score or positive deviation score. The provider is allocated one, two, or three predetermined scores based upon said classification.

In another embodiment, the specification discloses a method for evaluating a bid submitted by a provider during a bidding process, wherein said evaluation is performed by at least one processor executing instructions stored in a non-volatile memory, comprising: a) retrieving from a database a plurality of electronic records wherein said records comprise data representative of a provider's past performance with respect to one or more prior bids, wherein each of said prior bids comprise bid variables having associated therewith one or more bid variable values and wherein said data representative of a provider's past performance indicates whether said provider met, failed to meet, or performed better than said one or more bid variable values; b) determining a positive deviation score, wherein said positive deviation score is a measure of an extent to which the provider performed better than said one or more bid variable values; c) determining a negative deviation score, wherein said negative deviation score is a measure of an extent to which the provider failed to meet said one or more bid variable values; and d) ranking said bid, wherein said ranking is a function of at least one of said positive deviation or negative deviation score.

Optionally, the bid variables comprise at least one of cost, quantity, or completion deadline. The positive deviation score is determined if and only if the provider delivered a product or service, in response to one of said prior bids, at a cost below the cost bid variable, in a quantity greater than the quantity bid variable, or at a time earlier than the completion deadline bid variable and if and only if a) the provider did not deliver a product or service, in response to one of said prior bids, at a cost greater than the cost bid variable, in a quantity less than the quantity bid variable, and at a time later than the completion deadline bid variable or b) the provider delivered a product or service, in response to one of said prior bids, at a cost greater than the cost bid variable but below a threshold value, in a quantity less than the quantity bid variable but above a threshold value, and at a time later than the completion deadline bid variable but before a threshold value.

Optionally, the negative deviation score is determined if and only if the provider delivered a product or service, in response to one of said prior bids, at a cost greater than the cost bid variable, in a quantity less than the quantity bid variable, or at a time later than the completion deadline bid variable and if and only if a) the provider did not deliver a product or service, in response to one of said prior bids, at a cost less than the cost bid variable, in a quantity greater than the quantity bid variable, and at a time earlier than the completion deadline bid variable or b) the provider delivered a product or service, in response to one of said prior bids, at a cost less than the cost bid variable but above a threshold value, in a quantity greater than the quantity bid variable but below a threshold value, and at a time earlier than the completion deadline bid variable but later than a threshold value.

The method for evaluating a bid of claim 15 wherein said ranking is achieved, at least in part, by summing a first score and a second score, wherein said first score is an attribute utility function.

Optionally, the second score is determined by summing the positive deviation score, the negative deviation score, a third score, a fourth score, a fifth score, a sixth score, a seventh score, and an eighth score. The third score is a function of an average number of negative deviations of the provider and an average number of negative deviations of all providers engaged in said bidding process, said fourth score is a function of a total number of negative deviations of the provider across all recorded jobs and the average negative deviations of all providers engaged in said bidding process, said fifth score is a function of the provider's total number of positive deviations across all past performances for prior bids and the provider's total number of negative deviations across all past performances for prior bids, said sixth score is a function of individual bid evaluation scores for each of said prior bids relative to a total number of prior bids, and said seventh score is a ratio of a number of the provider's accepted bids relative to a number of the provider's submitted bids.

These and other embodiments shall be further explained and described in the Detailed Description section with reference to the Drawings

### BRIEF DESCRIPTION OF THE DRAWINGS

These and other features and advantages will be appreciated as they become better understood by reference to the following Detailed Description when considered in connection with the accompanying drawings, wherein:

FIG. 1 is a flowchart illustrating a method of computing a total bid score, in accordance with an embodiment of the present invention;

FIG. 2 is an illustration of an exemplary bid comprising a plurality of data fields; and

FIG. 3 is a flowchart illustrating a method of classifying providers, in accordance with an embodiment of the present invention.

### DETAILED DESCRIPTION

The present application discloses multiple embodiments. The following disclosure is provided in order to enable a person having ordinary skill in the art to practice the claimed inventions. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present application is to be accorded the widest scope encompassing numerous alternatives, modifications and equivalents consistent with the principles and features disclosed. For purpose of clarity, details relating to technical material that is known in the technical fields related to the claimed inventions have not been described in detail so as not to unnecessarily obscure the disclosure.

The computer implemented bid evaluation processes described herein are accessed or used by a user operating a computing device with a processor executing a plurality of programmatic instructions stored in a non-volatile, non-transient memory to receive data, transmit data, and display a graphical user interface representative of data generated from the execution of the plurality of programmatic instructions. The plurality of programmatic instructions may be architected in a single module executing on a single computing device, or in a plurality of modules distributed among a plurality of computing devices which are either local or remote to each other. Hence, the phrase “the system” refers to one or more computing devices executing a plurality of programmatic instructions, in the form of one or more modules, which, when executed, cause data to be received, accessed, processed, transmitted, and/or displayed in accordance with the bid evaluation methods disclosed herein. As used herein, the “computing device” is any device capable of processing, accessing or displaying electronic data, including personal computers, laptops, desktops, mobile phones, tablet PCs, or other computers.

The present application discloses methods for evaluating bids made by vendors during a request for proposal, bidding, or reverse auctioning process. For purposes of this application, “bid values” or a “bid” is any data set, whether in electronic or hard copy form, defining a plurality of values corresponding to a plurality of predefined categories, attributes, characteristics, variables, or vectors. For purposes of this application, a “bid evaluation process” shall mean any computer-implemented process designed to determine which bid, among a plurality of bids made by vendors, should be chosen in accordance with a plurality of evaluation factors. For purposes of this application, a provider, vendor, or bidder is any entity, including individual, corporation, partnership, limited liability partnership, venture, or other person, offering to provide a product or service.

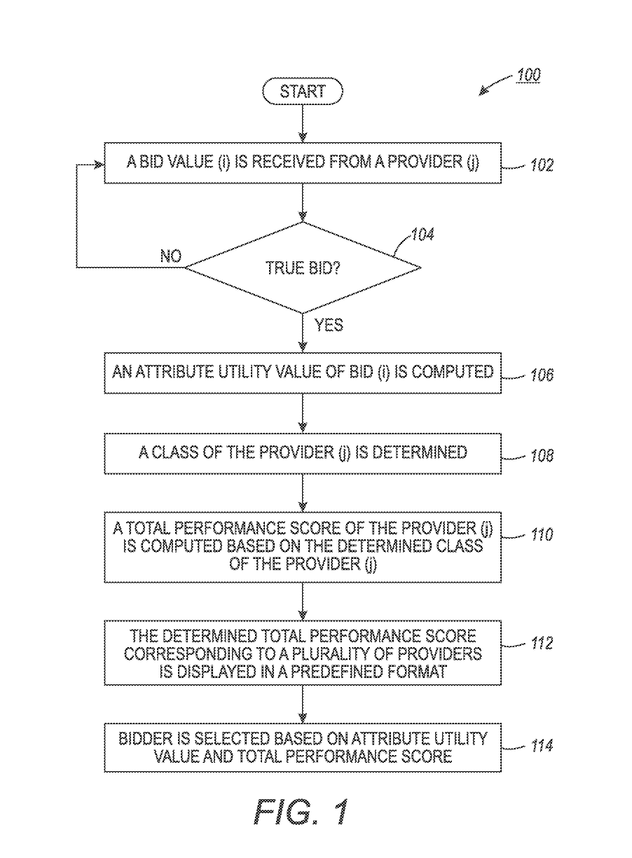

Referring to FIG. 1, a method 100 of evaluating a plurality of bids to select a bid and, correspondingly a vendor, is shown. The system receives bid values (i) from providers (j) 102. The system determines if the bid values (i) are true values 104. If the bid values (i) conform to predetermined criteria, the bid values are determined to be true, real, acceptable, or otherwise valid. If the bid values (i) do not conform to predetermined criteria, the bid values are determined to not be true, real, acceptable, or otherwise valid.

If the bid values (i) are true values, the system computes attribute utility values of bids (i) 106. In various embodiments, the attribute utility values may be computed by using one or more of known methods, such as but not limited to MAUT and AHP techniques. The system determines to what extent a provider has historically exceeded expectations or deviated from a committed value which results in a profitable scenario for a buyer, i.e. performed better than promised according to one or more prior bid values, referred to as a “positive deviation”. The system further determines to what extent a provider has historically failed to meet expectations or deviated from a committed value which results in a loss for a buyer, i.e. performed worse than promised according to one or more prior bid values, referred to as a “negative deviation”.

Based on the positive deviation and negative deviation scores, the system determines the classes of the providers (j) 108. The system then computes total performance scores of the providers (j) based, at least in part, on the determined classes 110. The system optionally displays the total performance scores of the providers (j) in a predefined format 112. The system recommends, suggests, or otherwise identifies one or more specific bidders based upon a sum of the attribute utility value associated with the provider's bid and the provider's total performance score 114.

It should be appreciated that the bid evaluation methodologies disclosed herein have numerous benefits, including evaluating a provider's bid in accordance with acceptable attribute utility value functions in combination with evaluating the provider itself by incorporating a plurality of calculated variables into a single total performance score. Such variables include: a) a provider's positive deviations, b) a provider's negative deviations, c) a provider's reliability, namely the provider's negative deviation relative to the average negative deviation of all providers, d) a provider's efficiency, namely the provider's ratio of positive to negative deviations, e) a provider's integrity or consistency, namely a measure of a provider's bid fulfillment behavior, f) a provider's average bid evaluation value obtained on prior jobs, and g) the number of times a provider's bid has been accepted in prior evaluations. Accordingly, the bid evaluation methodologies evaluate providers along three separate dimensions: conformance to committed values, qualitative performance among peers, and bid performance using data that has been obtained and stored in prior bid or auction processes. Each of the aforementioned process components shall now be discussed in greater detail.

The system receives bids from one or more providers. The bids may be received by any wired or wireless communication mechanism, including email, uploading a bid from a client device directly to a server, text messaging, posting to a website, or any other method of data distribution.

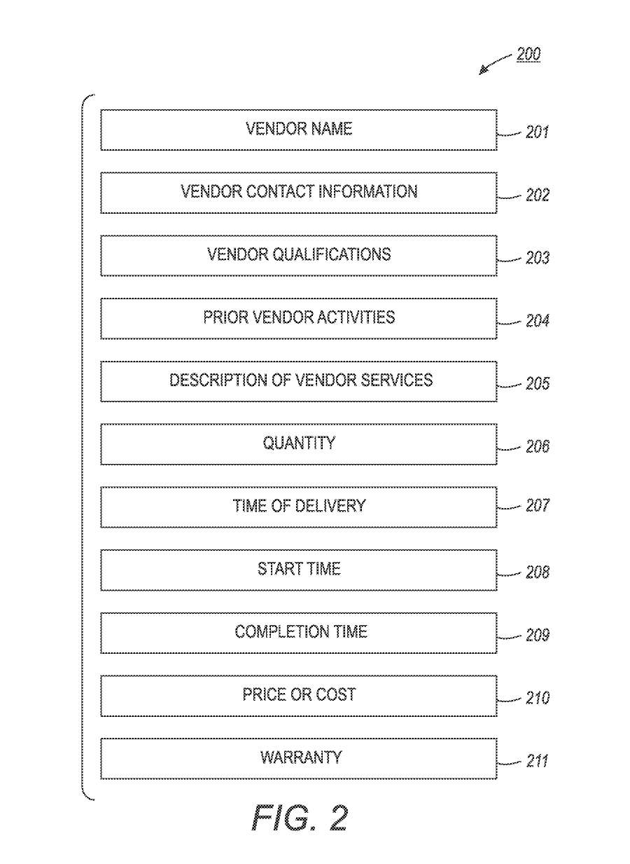

Upon receiving and storing a plurality of bids from a plurality of providers, the system determines if the bid values are true values, i.e. if the bid values conform to predetermined criteria. In one embodiment, the system extracts values for each variable associated with a bid. For example, a bid may include a plurality of fields, as shown in FIG. 2, which have typically been predefined by the entity seeking the bid. The bid 200 is a data structure which may be in the form of a structured data file, an XML data file, an unstructured data file, an ASCII file, a PDF formatted document, a faxed document in the form of an image file, i.e. TIF or JPEG format, or PDF file which has been subjected to an optical character recognition (OCR) process, or any other form of electronic data.

In one embodiment, the bid comprises one or more of the following fields: Vendor Name 201, Vendor Contact Information 202, Vendor Qualifications 203, Prior Vendor Activities 204, Description of Vendor Services 205, Quantity 206, Time of Delivery 207, Start Time 208, Completion Time 209, Price or Cost 210, Warranty 211, among other variables. The system extracts values associated with each of these fields, stores them in a database, and compares them to expected or predefined values to determine if the bid conforms to predetermined criteria. For example, predetermined criteria may be general, such as any value must be provided for a given field, or specific, such as a value within a predefined range, only values greater than a predefined value, or only values less than a predefined value. The system determines the values within the bid conform to the predetermined criteria established for each of the fields.

If the bid values do not conform to predetermined criteria, the bid values are determined to not be true, real, acceptable, or otherwise valid. In one embodiment, the system logs in a memory specific reasons, in the form of text statements, error codes, or other labels, why the bid values fail to conform to the predetermined criteria. For example, the system may determine that the bid values a) fail to include certain criteria, such as a starting date, a date of completion, a price, a warranty, name or contact information, vendor history, vendor qualifications, vendor references, a quantity, or some other variable or b) include criteria that is outside a predetermined range, such as a quantity below acceptable levels, a completion time beyond an acceptable time, or a price in excess of an acceptable cost. In one embodiment, the system communicates one or more reasons why the bid failed to conform to predetermined criteria by communicating the aforementioned specific reason, or a version thereof, to a vendor. In another embodiment, the system provides the vendor with an opportunity to resubmit the bid and reevaluates the bid, as described above, to determine if it now conforms with the predetermined criteria.

If the bid values conform to predetermined criteria, the system determines a bid evaluation value corresponding to each provider by summing an attribute utility score value and a total performance score of the provider. According, the bid evaluation methodologies disclose a provider performance scoring function which may be used with an existing attribute utility evaluation function to provide a complete bid evaluation function. The bid evaluation value may be represented as:

Bid Evaluation Value=Attribute Utility Score+Total Performance Score (1)

The system computes the utility value of each conforming bid. In various embodiments, the attribute utility values may be computed by using one or more of known methods, such as but not limited to MAUT and AHP methodologies. The attribute utility score specifies how much a bid is of utility to the buyer who calls for the bid, that is, how much the bid quantitatively fulfills the utility/purpose of the buyer. It should be appreciated that evaluating a bid by calculating an attribute utility score is known in the art and will not be further described herein.

Concurrent to, prior, or after the attribute utility value calculation, the system determines a provider's total performance score by evaluating the provider's past performance on a predetermined set of variables over a predetermined number of prior auctions. The variables chosen for evaluation are based on data, which are stored in a memory that is remote or local to the processors responsible for determining the provider's total performance score, during a predetermined number of prior auctioning processes, thereby relying on variables which were objectively measured during the prior provision of goods or services and minimizing, or fully eliminating, subjective evaluations of past performances during bid evaluation. In one embodiment, where the number of prior auctioning processes is not specified, all the auctioning processes in which a provider has participated are considered for evaluating the total performance score of the provider.

The past performance score of a provider enables evaluation of providers on at least three criteria, namely a provider's conformance to committed values, qualitative performance among peers and bid performance. The three performance metrics are computed by using information collected and recorded during one or more of auctioning processes, as described above, and are computed using scoring functions, not utility functions, thereby substantially minimizing or eliminating subjective input from buyers and providing objective performance measurement metrics. Stated differently, a utility function helps to determine how much a bid is of utility to a buyer by incorporating a weight value wᵢ for every bid attribute xᵢ as seen in the following function.

U(xⱼ)=Σᵢ₌₁ⁿwᵢ*AUᵢ(xⱼⁱ)

Because the weight value is provider subjective (since every provider may assign different weight values for different bid attributes), the same bid can have different utility values for different providers. However, a scoring function is not provider subjective and just calculates the score based on the values stored during prior bid transactions between the buyer and the provider. Furthermore, since the performance score is calculated based on values recorded during one or more prior auctioning processes, the possibility of buyer-provider collusion to artificially construct a high performance score is substantially minimized or eliminated.

In an embodiment, the total performance score is determined by computing a bid fulfillment score, a performance relative to other provider score, and a bid performance score for a given provider.

Total Performance Score=Bid Fulfillment Score+Performance Relative to Other Providers Score+Bid Performance Score (2)

A bid fulfillment score is calculated as a summation of a positive deviation score and a negative deviation score.

Bid Fullfillment Scoring Function=Positive Deviation Score+Negative Deviation Score (3)

For a given completed project, service, or product, the system determines a positive deviation if and only if each bid variable or vector is neutral (i.e. within bid expectations) or positive (i.e. better than bid expectations). For example, assume a) prior bid one was comprised of variables that include a measurement of time and cost, b) the provider had successfully bid a project by including a measurement of time of 7 days and a cost of $1,000, and c) the provider had successfully completed the project within 5 days and at a cost of $1,000, the system calculates a positive deviation for bid one because the actual time period for completion, 5 days, was less than the bid time period, 7 days, thereby being better than bid expectations.

Further, a positive deviation score is computed only if no negative vector is present (i.e. no bid variable is below expectations). For example, assume a) prior bid two was comprised of variables that include a measurement of time and cost, b) the provider had successfully bid a project by including a measurement of time of 7 days and a cost of $1,000, and c) the provider had successfully completed the project within 7 days but at a cost of $1,200, the system does not calculate a positive deviation for bid two because the actual cost is $200 over the bid cost, thereby being worse than bid expectations. It should be appreciated that any number of variables can be used to determine a positive deviation score.

In another embodiment, a positive deviation score is computed even if a negative vector is present, provided that at least one bid variable exceeds a threshold value. (i.e. a bid variable is far above expectations). For example, assume a) prior bid three was comprised of variables that include a measurement of time and cost, b) the provider had successfully bid a project by including a measurement of time of 7 days and a cost of $1,000, and c) the provider had successfully completed the project within 2 days but at a cost of $1,010, the system may calculate a positive deviation for bid three, even though the actual cost is $10 over the bid cost (thereby being worse than bid expectations) because the time variable of 2 days far exceeds the expected value of 7 days.

Similarly, in an embodiment, for a given completed project, service, or product, the system determines a negative deviation if and only if each bid variable or vector is negative (i.e. below bid expectations) or neutral (i.e. within bid expectations). For example, assume a) prior bid four was comprised of variables that include a measurement of time and cost, b) the provider had successfully bid a project by including a measurement of time of 7 days and a cost of $1,000, and c) the provider had completed the project within 8 days and at a cost of $1,000, the system calculates a negative deviation for bid four because the actual time period for completion, 8 days, was greater than the bid time period, 7 days, thereby being worse than bid expectations.

Further, a negative deviation score is computed only if no positive vector is present (i.e. a bid variable is above expectations). For example, assume a) prior bid five was comprised of variables that include a measurement of time and cost, b) the provider had successfully bid a project by including a measurement of time of 7 days and a cost of $1,000, and c) the provider had completed the project within 8 days but at a cost of $950, the system does not calculate a negative deviation for bid five because, while the actual cost is $50 below the bid cost, thereby being better than bid expectations, the time vector is worse than bid expectations. It should be appreciated that any number of variables can be used to determine a positive deviation score.

In another embodiment, a negative deviation score is computed even if a positive vector is present, provided that at least one bid variable exceeds a threshold value. (i.e. a bid variable is far below expectations). For example, assume a) prior bid six was comprised of variables that include a measurement of time and cost, b) the provider had successfully bid a project by including a measurement of time of 7 days and a cost of $1,000, and c) the provider had completed the project at a cost of $970 but over a period of 14 days, the system may calculate a negative deviation for bid six, even though the actual cost is $30 below the bid cost (thereby being better than bid expectations) because the time variable of 14 days is far worse than the expected value of 7 days.

As stated above, the system determines a positive deviation if a bid and completed project, product, or service resulted in one or more buyer profitable scenarios from among a set of predetermined buyer profitable scenarios and determines a negative deviation if a bid and completed project, product, or service resulted in one or more buyer loss scenarios from among a set of predetermined buyer loss scenarios. In one embodiment, to trigger the determination of a positive deviation, the one or more buyer profitable scenarios must occur independently, without the occurrence of one or more predetermined buyer loss scenarios. In one embodiment, to trigger the determination of a negative deviation, the one or more buyer loss scenarios must occur independently, without the occurrence of one or more predetermined buyer profitable scenarios.

Table 1 illustrates a set of buyer profitable scenarios in column one and a set of buyer loss scenarios in column two, in accordance with an exemplary embodiment of the invention.

TABLE 1

| Buyer profitable Scenarios | Buyer loss Scenarios |
|---|---|
| Discount in Cost | Increase of cost |
| Increase in Quantity | Decrease in Quantity |
| Job completion before deadline | Extension of deadline |
| Value additions given | |

For example, as illustrated in Table 1, a price discount offered after a final committed value in the bid without request for extension in deadline by a provider is a positive deviation. Similarly, a scenario where a provider gives ‘value additions’ without any additional obligations for the buyer as listed in the table, is considered as a positive deviation. Similarly, as illustrated in Table 1, scenarios such as increase of cost, lowering of quality, or an extension of deadline by a provider, represent buyer loss scenarios.

Based on the above, in one embodiment, the system determines a positive deviation score of a provider by determining a plurality of positive deviations in cost, time, quantity or value additions using the following formula, which is executed by a processor based upon data stored in a local or remote memory:

Positive Deviation Score=((PDC+PDT+PDQ+PDV)/JI)*10 (3)

### Wherein:

PDC denotes a Count of Positive Deviations in Cost;

PDT denotes a Count of Positive Deviations in Time;

PDQ denotes a Count of Positive Deviations in Quantity;

PDV denotes a Count of Positive Deviations in Value Additions provided; and

JI denotes a Number of Job Instances.

Since different providers may have different corresponding counts of auctioned job instances, the positive deviation values are preferably scaled to a number, such as 10.

Based on the above, in one embodiment, the system determines a negative deviation score of a provider by determining a plurality of negative deviations in cost, time, or quantity using the following formula, which is executed by a processor based upon data stored in a local or remote memory:

$$Negative Deviation Score = ( ( \frac{NAV}{JI} ) + NMD + NAT ) * 10 \qquad ( 4 )$$

### Wherein:

NAV denotes a Count of Negative Deviations in Attribute Values;

NMD denotes an Average Magnitude of Deviation from Committed Value;

NAT denotes an Average Deviation from Delivery Time; and

JI denotes a Number of Job Instances.

Since different providers may have different corresponding counts of auctioned job instances, the negative deviation values are preferably scaled to a number, such as 10.

In addition to determining a positive deviation score and/or negative deviation score for each of the provider's past projects, products, or services, the system further determines a performance relative to other providers score, or a performance among peers score, by determining and adding three scores: an integrity score, a reliability score, and an efficiency score.

Performance Relative to Other Providers Score=Integrity Score+Reliability Score+Efficiency Score (5)

A performance relative to other providers score, or performance among peers score, assesses a provider in comparison with other peer providers. The integrity score is used to determine the consistency of performance of a provider in prior auctioned jobs. A reliability score is used to evaluate a provider's performance as compared to one or more peer providers. An efficiency score is used to evaluate a provider's performance in meeting committed attribute values during prior auctioned jobs.

In one embodiment, the integrity score (IS) corresponding to a provider is calculated as:

$$\begin{matrix}AND = ABS ( \frac{TND}{JI} ) * 10 & ( 6 ) \\ TAND = ABS ( \frac{AND}{N} ) * 10 & ( 7 ) \\ If AND \leq TAND then IS = ABS ( 10 - ( TAND - AND ) \\ Else IS = ( 5 - ABS ( AND - TAND ) ) & ( 8 )\end{matrix}$$

### Wherein:

AND denotes an average number of negative deviations of a provider;

TND denotes a total number of negative deviations across all jobs considered;

TAND denotes an average of average negative deviations of all providers;

JI denotes a number of job instances considered for evaluation;

N denotes a total number of providers; and

IS denotes an integrity score of the provider.

The integrity score is a function of the average number of negative deviations of a provider and the average negative deviations of all providers. Providers who have a greater average number of negative deviations relative to the average negative deviations of all providers will have a lower integrity score. Conversely, providers who have a lower average number of negative deviations relative to the average negative deviations of all providers will have a higher integrity score.

In one embodiment, the reliability score corresponding to a provider may be calculated as:

Reliability=(TND/TAND)*10 (9)

### Wherein:

TND denotes a total number of negative deviations of a provider across all auctioned jobs being considered; and
TAND denotes an average of average negative deviations of all providers.

The reliability score is a function, such as a ratio, of the total number of negative deviations of a provider across all recorded jobs and the average negative deviations of all providers. Conversely, providers who have a lower total number of negative deviations relative to the average negative deviations of all providers will have a lower integrity score.

In one embodiment, the efficiency score corresponding to a provider may be calculated as:

$$\begin{matrix}EAP = ( \frac{{\sum }_{i = 1}^{n} ( PNDi / TNDi )}{n} ) & ( 10 ) \\ EPi = \frac{( \frac{PNDi}{TNDi} )}{EAP} * 10 & ( 11 )\end{matrix}$$

### Wherein:

EAP denotes an average efficiency of all providers participating in an auctioning process;
TNDi denotes a total number of negative deviations across all jobs considered of a provider I;
PNDi denotes a total number of positive deviations across all jobs considered of a provider I; and
EPi denotes an efficiency of a Provider i.

The efficiency score is a function, such as a ratio, of the total number of positive deviations across all jobs for a given provider and a total number of negative deviations across all jobs considered for a given provider. Providers who have a greater total number of positive deviations relative to negative deviations will have a higher efficiency score. Conversely, providers who have a lower total number of positive deviations relative to negative deviations will have a lower efficiency score.

In addition to determining a positive deviation score, negative deviation score, integrity score, reliability score, and/or efficiency score based on the provider's past projects, products, or services, the system further determines a bid performance score. Bid performance scores are calculated as sum of a bid evaluation score and a bid acceptance score.

Bid Performance Score=Bid Evaluation Score+Bid Acceptance Score (12)

A bid evaluation score represents an average bid evaluation value obtained by a provider during prior auctioned jobs. A bid acceptance score indicates the number of times a provider's bid has been accepted in prior auction evaluations.

In one embodiment, a bid evaluation score corresponding to a provider is calculated as:

$$Bid Evaluation = ( \frac{{\sum }_{1}^{n} ( {IBE}_{i} )}{n} ) * 5 \qquad ( 13 )$$

### Wherein:

IBEᵢ denotes an individual bid evaluation score for the auctioned job, I; and

n denotes the total number of auctioned jobs on which bids were accepted.

The bid evaluation score is a function, such as a summation, of the individual bid evaluation scores for a given auctioned job taken over the total number of auctioned jobs for which bids were accepted.

In one embodiment, a bid acceptance score corresponding to a provider may be calculated as:

$$Bid Acceptance = ( \frac{BA}{BS} ) * 5 \qquad ( 14 )$$

### Wherein:

BA denotes the number of accepted bids; and

BS denotes the number of submitted bids.

The bid acceptance score is a function, such as a ratio, of the number of a provider's accepted bids relative to the number of a provider's submitted bids. The more bids a provider has historically had accepted, the higher the provider's bid acceptance score.

In an embodiment, every component of the performance score is calculated individually by using equations 3-14 and then substituted in equation 2 to obtain a total performance score function which in turn is substituted in equation 1 to obtain a total bid score corresponding to a provider.

Total Performance Score=Positive Deviation Score+Negative Deviation Score+Integrity Score+Reliability Score+Efficiency Score+Bid Evaluation Score+Bid Acceptance Score (15)

In one embodiment, a total bid score function corresponding to a provider may be computed by using the following equation:

V(Bⱼ)=(Σᵢ₌₁ⁿAUₜ(xⱼⁱ))+PS(Pⱼ) (16)

### Wherein:

V(Bⱼ) is the evaluation value of bid Bⱼ of a provider, j;

AUᵢ(xⱼⁱ) is the attribute utility of attribute xⁱ on bid provided by a provider, j;

Σᵢ₌₁ⁿAUᵢ(xⱼⁱ) is the utility value of the n attributes in bid of a provider, j; and

PS(Pⱼ) is the Performance Score of a provider, j.

PS(Pⱼ) is the proposed scoring function, calculated as a summation of three components as follows:

PS(Pⱼ)=DS(Pⱼ)+PPS(Pⱼ)+BPS(Pⱼ) (17)

### Wherein:

DS(Pⱼ) is the bid fulfillment score of a provider, j;

PPS(Pⱼ) is the Performance Among Peers score of a provider, j; and

BPS(Pⱼ) is the Bid Performance score of a provider, j.

To yield a final total performance score, system further classifies a provider into one of a plurality of classes and then weights individual components of the provider's total performance score based on the classification, thereby scaling the performance score based on a provider's history.

The class of the provider is selected from among a set of predefined classes based upon the number of positive and/or negative deviations attributable to the provider. In one embodiment, the set of predefined classes comprise five classes defined based on performance deviations of a provider. A set of exemplary class definitions are as follows:

Class I—New providers who have submitted a bid for the first time (there is no record of participation of these providers in any prior auctioning processes);

Class II—Providers who have no positive or negative deviations in all prior auctioned jobs done;

Class III—Providers who have only positive deviations;

Class IV—Providers who have both positive and negative deviations; and

Class V—Providers who have only negative deviations.

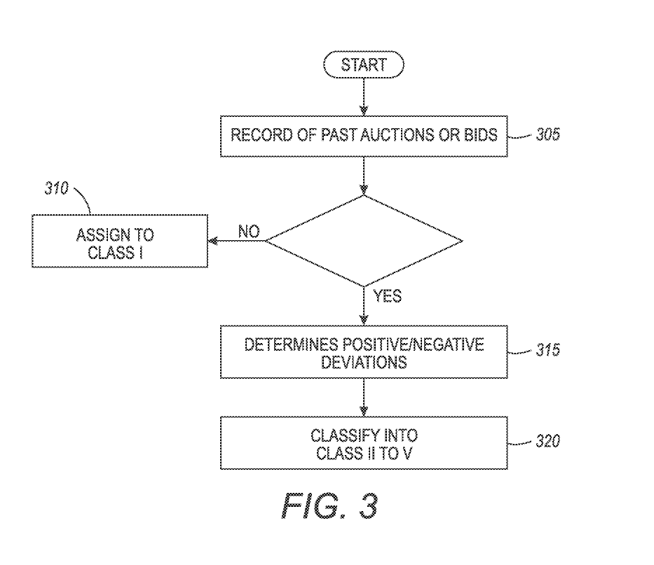

Accordingly, referring to FIG. 3, the system determines 305 if a provider has a record of having submitted a bid in prior bidding processes. If not, the system assigns 310 the provider to Class I. If so, the system determines 315 a plurality of positive and/or negative deviations attributable to the provider based on the provider's prior bid history. The system then classifies 320 the provider based on the plurality of positive and/or negative deviations, in accordance with the class descriptions above.

In one embodiment, total performance scores are normalized to 100 with each of the positive deviation, negative deviation and peer performance scores being allotted 30 points out of the 100. The remaining 10 points are allocated to bid performance score. The above may be represented as:

Total performance score(100)=Positive deviation(30)+Negative deviation(30)+Peer performance score(30)+Bid performance score(10) (18)

As shown in Table 1 below, in one embodiment, the total bid score of a provider belonging to Class I is determined solely based on the attribute utility score of the provider. In one embodiment, the total bid score of a provider belonging to Class II is allocated 30 points each with respect to positive deviation, negative deviation and peer performance score, with the bid performance score being equal to the actual calculated sum, in accordance with equation 12. In one embodiment, the total bid score of a provider belonging to Class III is allocated 30 points each corresponding to negative deviation and peer performance scores with the positive deviation score and bid performance score being equal to the actual calculated sums, in accordance with equations 3 and 12, respectively. In one embodiment, the total bid score of a provider belonging to Class IV is determined using the actual calculated sums for the positive deviation score, negative deviation score, peer performance score and bid performance score, in accordance with equations 3, 4, 5 and 12, respectively. In one embodiment, the total bid score of a provider belonging to Class V is determined using the actual calculated sums for the negative deviation score, peer performance score and bid performance score, in accordance with equations 4, 5 and 12, respectively, with the positive deviation score being assigned a value of 0.

TABLE 2

| | | | | Peer | | |
|---|---|---|---|---|---|---|
| | | Positive | Negative | Performance | Bid | Total |
| | Type of | Deviation | Deviation | Score | Performance | (100) |
| S. No. | Provider | Score (30) A | Score (30) B | (30) C | Score (10) D | A + B + C + D |
| 1. | Class I | NA | | | | |
| | (New | | | | | |
| | Providers) | | | | | |
| 2. | Class II | 30 | 30 | 30 | Calculated | |
| | (Providers | | | | value | |
| | with no | | | | | |
| | positive & | | | | | |
| | negative | | | | | |
| | deviations) | | | | | |
| 3. | Class III | Calculated | 30 | 30 | Calculated | |
| | (Providers | Value | | | Value | |
| | with only | | | | | |
| | positive | | | | | |
| | deviations) | | | | | |
| 4. | Class IV | Calculated | Calculated | Calculated | Calculated | |
| | (Providers | Value | Value | Value | Value | |
| | with both | | | | | |
| | positive | | | | | |
| | and | | | | | |
| | negative | | | | | |
| | deviations) | | | | | |
| 5. | Class V | 0 | Calculated | Calculated | Calculated | |
| | (Providers | | Value | Value | Value | |
| | with only | | | | | |
| | negative | | | | | |
| | deviations) | | | | | |

It should be appreciated that, while values of 30, 100, and 10, are disclosed herein, any set of values may be applied to weight the relative importance of the scores. In particular, any classification scheme that separates providers based on determining the existence, or non-existence, of positive and/or negative deviations and the allocation of value based on such determination falls within the scope of the disclosed embodiments. Further, classifications which assign equal value for the positive deviation, negative deviation, and peer performance scores in the event of having no positive or negative deviations, which assign equal value for negative deviation and peer performance scores in the event of having only positive deviations, and which assign a value of 0 for positive deviation in the event of having only negative deviations are within the scope of the disclosed embodiments.

At step 110 the determined total score corresponding to a plurality of providers is displayed in a predefined format. In an embodiment, the results are displayed class-wise, with the providers in descending order of score as illustrated in Tables 3 and 4 below. Tables 3 and 4 display a provider's identification, class of a provider, an attribute utility value corresponding to a provider, a computed performance score computed to the provider, a total bid value computed by summing the attribute utility value and the performance score corresponding to a provider and a rank of a provider. In an embodiment, a rank of a provider is determined based on the total bid value computed with respect to the provider. A provider having a higher total bid value is assigned a higher rank than a provider having a lower total bid value.

Table 3 displays evaluation scores of new providers only, i.e. providers belonging to Class I:

TABLE 3

| | | | Attribute | Perfor- | Bid | |
|---|---|---|---|---|---|---|
| | Provider | Class of | Utility | mance | Evaluation | |
| S. No. | id | Provider | value | Score | Value | Rank |
| 1. | 1108 | Class I | 70 | NA | 70 | I |
| | | New | | | | |
| | | Provider | | | | |
| 2. | 1129 | Class I | 65 | NA | 65 | II |
| | | New | | | | |
| | | Provider | | | | |
| 3. | 1113 | Class I | 60 | NA | 60 | III |
| | | New | | | | |
| | | Provider | | | | |

Table 4 displays evaluation scores of all providers belonging to Classes II, III, and IV:

TABLE 4

| | | | Attribute | Perfor- | Bid | |
|---|---|---|---|---|---|---|
| | Provider | Class of | Utility | mance | Evaluation | |
| S. No. | id | Provider | value | Score | Value | Rank |
| 1. | 3989 | Class II | 78 | 98 | 176 | I |
| | | Provider | | | | |
| | | with no | | | | |
| | | positive & | | | | |
| | | negative | | | | |
| | | deviations | | | | |
| 2. | 3425 | Class III | 78 | 76 | 154 | II |
| | | Provider | | | | |
| | | with only | | | | |
| | | positive | | | | |
| | | deviations | | | | |
| 3. | 2676 | Class III | 73 | 75 | 148 | III |
| | | Provider | | | | |
| | | with only | | | | |
| | | positive | | | | |
| | | deviations | | | | |
| 4. | 1845 | Class IV | 86 | 60 | 146 | IV |
| | | Providers | | | | |
| | | with both | | | | |
| | | positive | | | | |
| | | and | | | | |
| | | negative | | | | |
| | | deviations | | | | |
| 5. | 3389 | Class IV | 80 | 58 | 138 | V |
| | | Providers | | | | |
| | | with both | | | | |
| | | positive | | | | |
| | | and | | | | |
| | | negative | | | | |
| | | deviations | | | | |

In sum, the present application discloses comprehensive provider performance scoring systems and methods which may be used along with an existing attribute utility evaluation method for providing a complete total bid evaluation function. It will be appreciated that various above-disclosed embodiments, other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A method for evaluating a bid submitted by a provider during a bidding process, wherein said evaluation is performed by at least one processor executing instructions stored in a non-volatile memory, comprising:
a. Retrieving from a database a plurality of electronic records wherein said records comprise data representative of a provider's past performance with respect to one or more prior bids, wherein each of said prior bids comprise bid variables having associated therewith one or more bid variable values and wherein said data representative of a provider's past performance indicates whether said provider met, failed to meet, or performed better than said one or more bid variable values;
b. Determining a positive deviation score, wherein said positive deviation score is a measure of an extent to which the provider performed better than said one or more bid variable values and wherein said positive deviation score is only determined if the data representative of a provider's past performance indicates the provider did not fail to meet any of said one or more bid variable values;
c. Determining a negative deviation score, wherein said negative deviation score is a measure of an extent to which the provider failed to meet said one or more bid variable values and wherein said negative deviation score is only determined if the data representative of a provider's past performance indicates the provider did not perform better than any of said one or more bid variable values; and
d. Ranking said bid, wherein said ranking is a function of at least one of said positive deviation or negative deviation score.

2. The method for evaluating a bid of claim 1 wherein said bid variables comprise at least one of cost, quantity, or completion deadline.

3. The method for evaluating a bid of claim 2 wherein the positive deviation score is determined if and only if the provider delivered a product or service, in response to one of said prior bids, at a cost below the cost bid variable, in a quantity greater than the quantity bid variable, or at a time earlier than the completion deadline bid variable and if and only if the provider did not deliver a product or service, in response to one of said prior bids, at a cost greater than the cost bid variable, in a quantity less than the quantity bid variable, and at a time later than the completion deadline bid variable.

4. The method for evaluating a bid of claim 2 wherein the negative deviation score is determined if and only if the provider delivered a product or service, in response to one of said prior bids, at a cost greater than the cost bid variable, in a quantity less than the quantity bid variable, or at a time later than the completion deadline bid variable and if and only if the provider did not deliver a product or service, in response to one of said prior bids, at a cost less than the cost bid variable, in a quantity greater than the quantity bid variable, and at a time earlier than the completion deadline bid variable.

5. The method for evaluating a bid of claim 1 wherein said ranking is achieved, at least in part, by summing a first score and a second score, wherein said first score is an attribute utility function.

6. The method for evaluating a bid of claim 5 wherein said attribute utility function is determined by using a MAUT or AHP methodology.

7. The method for evaluating a bid of claim 5 wherein said second score is determined by summing the positive deviation score, the negative deviation score, a third score, a fourth score, a fifth score, a sixth score, a seventh score, and an eighth score.

8. The method for evaluating a bid of claim 7 wherein said third score is a function of an average number of negative deviations of the provider and an average number of negative deviations of all providers engaged in said bidding process.

9. The method for evaluating a bid of claim 7 wherein said fourth score is a function of a total number of negative deviations of the provider across all recorded jobs and the average negative deviations of all providers engaged in said bidding process.

10. The method for evaluating a bid of claim 7 wherein said fifth score is a function of the provider's total number of positive deviations across all past performances for prior bids and the provider's total number of negative deviations across all past performances for prior bids.

11. The method for evaluating a bid of claim 7 wherein said sixth score is a function of individual bid evaluation scores for each of said prior bids relative to a total number of prior bids.

12. The method for evaluating a bid of claim 7 wherein said seventh score is a ratio of a number of the provider's accepted bids relative to a number of the provider's submitted bids.

13. The method for evaluating a bid of claim 1 wherein the provider is classified into a plurality of classes based upon at least one of said negative deviation score or positive deviation score.

14. The method for evaluating a bid of claim 13 wherein the provider is allocated one, two, or three predetermined scores based upon said classification.

15. A method for evaluating a bid submitted by a provider during a bidding process, wherein said evaluation is performed by at least one processor executing instructions stored in a non-volatile memory, comprising:
a. Retrieving from a database a plurality of electronic records wherein said records comprise data representative of a provider's past performance with respect to one or more prior bids, wherein each of said prior bids comprise bid variables having associated therewith one or more bid variable values and wherein said data representative of a provider's past performance indicates whether said provider met, failed to meet, or performed better than said one or more bid variable values;
b. Determining a positive deviation score, wherein said positive deviation score is a measure of an extent to which the provider performed better than said one or more bid variable values;
c. Determining a negative deviation score, wherein said negative deviation score is a measure of an extent to which the provider failed to meet said one or more bid variable values; and
d. Ranking said bid, wherein said ranking is a function of at least one of said positive deviation or negative deviation score.

16. The method for evaluating a bid of claim 15 wherein said bid variables comprise at least one of cost, quantity, or completion deadline.

17. The method for evaluating a bid of claim 16 wherein the positive deviation score is determined if and only if the provider delivered a product or service, in response to one of said prior bids, at a cost below the cost bid variable, in a quantity greater than the quantity bid variable, or at a time earlier than the completion deadline bid variable and if and only if a) the provider did not deliver a product or service, in response to one of said prior bids, at a cost greater than the cost bid variable, in a quantity less than the quantity bid variable, and at a time later than the completion deadline bid variable or b) the provider delivered a product or service, in response to one of said prior bids, at a cost greater than the cost bid variable but below a threshold value, in a quantity less than the quantity bid variable but above a threshold value, and at a time later than the completion deadline bid variable but before a threshold value.

18. The method for evaluating a bid of claim 16 wherein the negative deviation score is determined if and only if the provider delivered a product or service, in response to one of said prior bids, at a cost greater than the cost bid variable, in a quantity less than the quantity bid variable, or at a time later than the completion deadline bid variable and if and only if a) the provider did not deliver a product or service, in response to one of said prior bids, at a cost less than the cost bid variable, in a quantity greater than the quantity bid variable, and at a time earlier than the completion deadline bid variable or b) the provider delivered a product or service, in response to one of said prior bids, at a cost less than the cost bid variable but above a threshold value, in a quantity greater than the quantity bid variable but below a threshold value, and at a time earlier than the completion deadline bid variable but later than a threshold value.

19. The method for evaluating a bid of claim 15 wherein said ranking is achieved, at least in part, by summing a first score and a second score, wherein said first score is an attribute utility function.

20. The method for evaluating a bid of claim 19 wherein said second score is determined by summing the positive deviation score, the negative deviation score, a third score, a fourth score, a fifth score, a sixth score, a seventh score, and an eighth score.

21. The method for evaluating a bid of claim 20 wherein said third score is a function of an average number of negative deviations of the provider and an average number of negative deviations of all providers engaged in said bidding process, said fourth score is a function of a total number of negative deviations of the provider across all recorded jobs and the average negative deviations of all providers engaged in said bidding process, said fifth score is a function of the provider's total number of positive deviations across all past performances for prior bids and the provider's total number of negative deviations across all past performances for prior bids, said sixth score is a function of individual bid evaluation scores for each of said prior bids relative to a total number of prior bids, and said seventh score is a ratio of a number of the provider's accepted bids relative to a number of the provider's submitted bids.
